(19) United States
(12) Patent Application Publication
(10) Pub. No.: US 2018/0210701 A1
(43) Pub. Date: Jul. 26, 2018

(54) KEYWORD DRIVEN VOICE INTERFACE

(71) Applicant: Essential Products, Inc., Palo Alto, CA (US)

(72) Inventors: Mara Clair Segal, San Francisco, CA (US); Manuel Roman, Sunnyvale, CA (US); Dwipal Desai, Palo Alto, CA (US); Andrew E. Rubin, Los Altos, CA (US)

(21) Appl. No.: 15/600,523

(22) Filed: May 19, 2017

Related U.S. Application Data
(60) Provisional application No. 62/450,182, filed on Jan. 25, 2017.
(60) Provisional application No. 62/486,408, filed on Apr. 17, 2017.

(51) Int. Cl. G06F 3/16; G10L 15/22; G10L 15/08; G10L 15/02; G06F 3/0484

(52) U.S. Cl. CPC G06F 3/167; G10L 15/22; G10L 15/08; G10L 2015/088; G06F 3/0484; G10L 2015/223; G10L 15/02

(57) ABSTRACT

Keyword driven voice interfaces are described. An assistant device can provide a graphical user interface (GUI) on a display screen. The GUI can be adjusted based on receiving voice input (e.g., speech) having a keyword representing an action to perform the adjustment.

### CLAIM FOR PRIORITY

This application claims priority to U.S. Provisional Patent Application No. 62/450,182 (Attorney Docket No. 119306-8055.US00), entitled “Keyword Driven Voice Interface,” by Segal et al., and filed on Jan. 25, 2017. This application also claims priority to U.S. Provisional Patent Application No. 62/486,408 (Attorney Docket No. 119306-8071.US00), entitled “Keyword Driven Voice Interface,” by Segal et al., and filed on Apr. 17, 2017. The content of the above-identified applications are incorporated herein by reference in their entirety.

### TECHNICAL FIELD

This disclosure relates to user interfaces, and in particular a user interface that is driven by voice input including keywords.

### BACKGROUND

The Internet of Things (IoT) allows for the internetworking of devices to exchange data among themselves to enable sophisticated functionality. For example, devices configured for home automation can exchange data to allow for the control and automation of lighting, air conditioning systems, security, etc.

In the smart home environment, this can also include home assistant devices providing an intelligent personal assistant to respond to speech. For example, a home assistant device can include a microphone array to receive voice input and provide the corresponding voice data to a server for analysis, for example, to provide an answer to a question asked by a user. The server can provide the answer to the home assistant device, which can provide the answer as voice output using a speaker. As another example, the user can provide a voice command to the home assistant device to control another device in the home, for example, a light bulb. As such, the user and the home assistant device can interact with each other using voice, and the interaction can be supplemented by a server outside of the home providing the answers. Improving the responsiveness of the home assistant device to the user is becoming increasingly important.

### SUMMARY

Some of the subject matter described herein includes a home assistant device, comprising: a display screen; a microphone; one or more processors; and memory storing instructions, wherein the processor is configured to execute the instructions such that the processor and memory are configured to: provide a graphical user interface (GUI) on the display screen of the home assistant device; receive voice input including speech having a keyword representing an action for the assistant device to perform based on the GUI, the action representing a request for the home assistant device to perform functionality resulting in changes to the GUI; determine characteristics of the speech and of a user providing the speech; and adjust the GUI on the display screen based on the action, the characteristics of the speech, and the characteristics of the user.

Some of the subject matter described herein also includes a method for providing a contextual user interface, comprising: providing, by a processor, a graphical user interface (GUI) on a display screen of an assistant device; receiving voice input including speech having a keyword representing an action for the assistant device to perform based on the GUI; and adjusting the GUI on the display screen based on the action.

In some implementations, the method includes: determining characteristics of the speech, wherein adjusting the GUI is further based on the characteristics of the speech.

In some implementations, wherein the determining characteristics of the speech includes how the speech was spoken.

In some implementations, the characteristics includes one or more of volume, intonation, or cadence of the speech.

In some implementations, the method includes: determining characteristics of a user providing the speech, wherein adjusting the GUI is further based on the characteristics of the user.

In some implementations, the characteristics of the user includes a visual orientation of the user in relation to the assistant device.

In some implementations, adjusting the GUI includes providing items having different characteristics than items of the GUI before the adjusting.

Some of the subject matter described herein also includes an electronic device, comprising: one or more processors; and memory storing instructions, wherein the processor is configured to execute the instructions such that the processor and memory are configured to: provide a graphical user interface (GUI) on a display screen of an assistant device; receive voice input including speech having a keyword representing an action for the assistant device to perform based on the GUI; and adjust the GUI on the display screen based on the action.

In some implementations, the processor is configured to execute the instructions such that the processor and memory are configured to: determine characteristics of the speech, wherein adjusting the GUI is further based on the characteristics of the speech.

In some implementations, determining characteristics of the speech includes how the speech was spoken.

In some implementations, the characteristics includes one or more of volume, intonation, or cadence of the speech.

In some implementations, the processor is configured to execute the instructions such that the processor and memory are configured to: determine characteristics of a user providing the speech, wherein adjusting the GUI is further based on the characteristics of the user.

In some implementations, the characteristics of the user includes a visual orientation of the user in relation to the assistant device.

In some implementations, adjusting the GUI includes providing items having different characteristics than items of the GUI before the adjusting.

Some of the subject matter disclosed herein also includes a computer program product, comprising one or more non-transitory computer-readable media having computer program instructions stored therein, the computer program instructions being configured such that, when executed by one or more computing devices, the computer program instructions cause the one or more computing devices to: provide a graphical user interface (GUI) on a display screen of an assistant device; receive voice input including speech having a keyword representing an action for the assistant device to perform based on the GUI; and adjust the GUI on the display screen based on the action.

In some implementations, the processor is configured to execute the instructions such that the processor and memory are configured to: determine characteristics of the speech, wherein adjusting the GUI is further based on the characteristics of the speech.

In some implementations, the determining characteristics of the speech includes how the speech was spoken.

In some implementations, the characteristics includes one or more of volume, intonation, or cadence of the speech.

In some implementations, the processor is configured to execute the instructions such that the processor and memory are configured to: determine characteristics of a user providing the speech, wherein adjusting the GUI is further based on the characteristics of the user.

In some implementations, the characteristics of the user includes a visual orientation of the user in relation to the assistant device.

### BRIEF DESCRIPTION OF THE DRAWINGS

FIG. 1 illustrates an example of an assistant device providing a graphical user interface (GUI) based on the content of voice input.

FIG. 2 illustrates an example of a block diagram providing a GUI based on the content of the voice input.

FIG. 3 illustrates an example of a block diagram providing a GUI based on characteristics of voice input and/or a user.

FIG. 4 illustrates an example of an assistant device.

### DETAILED DESCRIPTION

This disclosure describes devices and techniques for providing a graphical user interface (GUI) of an assistant device. In one example, the assistant device in a home can include a display screen which can provide a GUI in response to a user's speech. For example, the user might ask the assistant device for information, such as a listing of new restaurants that have opened in the neighborhood in the last year. The assistant device can generate a GUI to be displayed on its display screen visually portraying some of the results of a search for the new restaurants. The user can interact with the assistant device using his voice. If the user's voice includes certain keywords, then the assistant device can recognize those keywords and determine that they represent an action to undertake to adjust the GUI in line with the user's expectations. For example, if the GUI is displaying a list of restaurants, the user can say “next.” The assistant device can recognize “next” as a keyword that should result in some functionality to be performed. In this example, because the assistant device has generated a GUI providing a list, it can then scroll through the list to provide another selection of restaurants to display with the GUI.

In another example, the assistant device can determine characteristics of the user's voice (e.g., how the speech was spoken) and use those characteristics to determine how to adjust the GUI in response to the user's voice. In another example, the assistant device can determine characteristics of the user (e.g., whether the user is looking at the assistant device) to determine how to adjust the GUI in response to the user's voice.

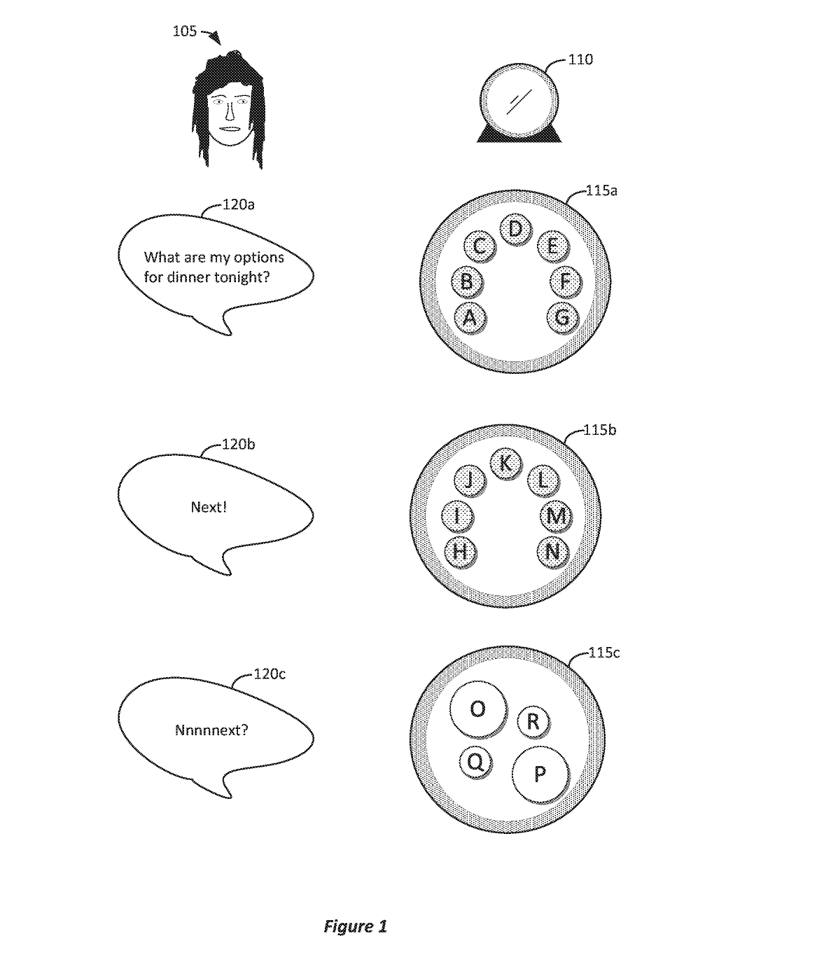

In more detail, FIG. 1 illustrates an example of an assistant device providing a graphical user interface (GUI) based on the content of voice input. In FIG. 1, user 105 can interact with assistant device 110 using speech. Assistant device 110 can include a microphone (e.g., a microphone array) to receive voice input (or speech) from users and a speaker to provide audio output in the form of speech or other types of audio to respond to the user. Additionally, assistant device 110 can include a display screen to provide visual feedback to users. Additional visual components, such as light emitting diodes (LEDs), can also be included. As a result, the user interface can include audio, voice, displays screen, and other visual components. In some implementations, a camera can also be included for assistant device 110 to receive visual input of its surrounding environment. The camera can be physically integrated (e.g., physically coupled with) with home assistant device 110 or the camera can be a separate component of a home's wireless network that can provide video data to assistant device 110.

In FIG. 1, user 105 can provide speech 120a to assistant device 110. Speech 120a includes a command or request for assistant device 110 to visually portray data in response to the command on a display screen as GUI 115a. In FIG. 1, this can be a listing of items A-G if the command of speech 120a is asking for search results, a list, etc.

In some scenarios, user 105 can touch the display screen of assistant device 110 to further interact with assistant device 110 after it has provided the results as GUI 115a. For example, items A-G can be a mere subset of the total results. As such, user 105 can touch a button or display screen (e.g., if it is touch-sensitive the user can provide a gesture such as swiping upon the display screen) to indicate to assistant device 110 that it should change GUI 115a to provide new results. However, sometimes user 105 might have her hands unavailable and, therefore, cannot interact with assistant device 110 with his hands. For example, user 105 might be engaged in an activity using both of her hands (e.g., carrying a package, cooking, playing a guitar, etc.). Additionally, providing buttons on the display screen can take up valuable real estate of the display screen that could otherwise be used to display other content, including additional results.

In some implementations, assistant device 110 can adjust GUI 115a in response to the speech of user 105. That is, the GUI provided by the display screen of assistant device 110 can be adjusted based on the speech of user 105. This can allow for the hands-free operation interaction with assistant device 110 and user 105, resulting in a more speech-centric interaction experience.

In FIG. 1, this can result in user 105 speaking speech 120b including the command “Next!” which can be detected by assistant device 110. Assistant device 110 can include a local dictionary including data and resources (e.g., software, circuits, etc.) that can be used to identify a small set of keywords that can be used by user 105 to interact with the GUI that assistant device 110 provides. In FIG. 1, the keyword of “Next!” can be determined by assistant device 110 to scroll through the list of results of the search provided as GUI 115a. For example, GUI 115b providing a listing of items H-N rather than items A-G as depicted for GUI 115a can be provided. That is, assistant device 110 can adjust, or generate, the display screen or GUI to provide new results based on the keyword identified in speech 120b.

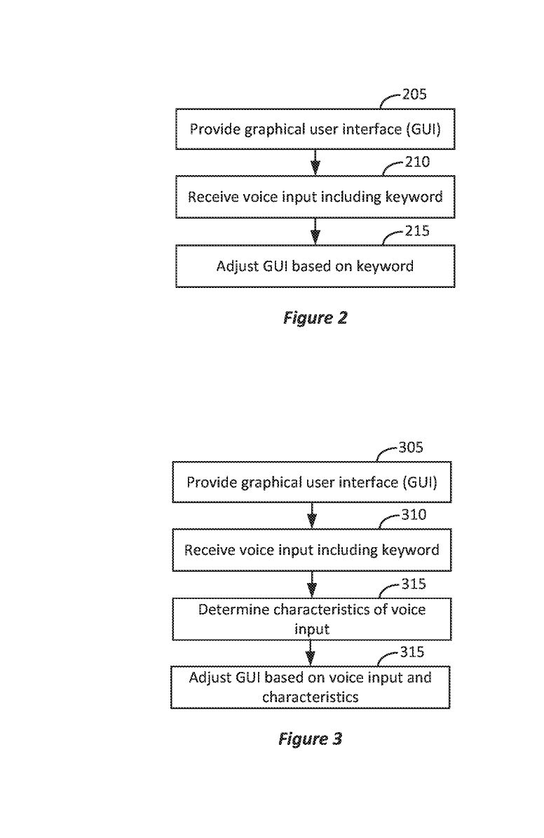

FIG. 2 illustrates an example of a block diagram providing a GUI based on the content of the voice input. In FIG. 2, at block 205, a GUI can be provided on a display screen of an assistant device. For example, in FIG. 1, GUI 115a can be provided on the display screen of assistant device 110 in response to speech 120a. At block 210, voice input including a keyword can be received. For example, in FIG. 1, assistant device 110 can recognize a small set of keywords as representing actions to perform on a GUI that it provides on its display screen. At block 215, the GUI can be adjusted based on the keyword. For example, in FIG. 1, assistant device can adjust the GUI among GUIs 115a-c in FIG. 1 based on the content such as the keyword of speech 120a-c.

In addition to adjusting the GUI based on the content of the speech of user 105 as discussed above, the characteristics of the speech (e.g., how the speech was spoken) can be determined and used to adjust the GUI. For example, in FIG. 1, speech 120c can include the same keyword or content as speech 120b (i.e., “next”), but spoken differently. Assistant device 110 can determine characteristics of the speech, such as stuttering, cadence, volume, intonation, speed, accent, etc. and take those into account to determine how to adjust the GUI.

For example, in FIG. 1, speech 120c can include the same keyword as speech 120b (i.e., “next”), but spoken differently. Assistant device 110 can determine that the keyword of speech 120c was spoken with some uncertainty as opposed to speech 120b when it was spoken more directly, forcefully, etc. that is associated with more certainty. That is, assistant device 110 can determine that the keyword of speech 120c was spoken with lower confidence as to the results of GUI 115b provided on the screen than speech 120b as to the results provided by GUI 115a. For example, if user 105 sees GUI 115a and speaks speech 120b, this can be detected as being spoken with confidence (e.g., without detection of characteristics corresponding with lack of confidence, low confidence, etc.) and therefore GUI 115b can include some visual characteristics similar to GUI 115a, including the size of the items, number of items, orientation of items, etc. By contrast, if user 105 sees GUI 115b and speaks speech 120c, characteristics of speech 120c can be determined and if it is determined that those characteristics correspond with a lack of confidence then GUI 115c can include a different number of items, size of items, orientation of items, etc. than GUI 115b.

Confidence of speech is used in the above example. However, in other implementations, other characteristics of the speech can be used and correlated with other indications of the user. For example, how quickly the user is speaking can be correlated with urgency. As assistant device 110 generates a GUI and displays different results in response to speech (e.g., cycling through a list of restaurants), this might result in graphical animations in between the transitions from providing different sets of content. For example, in FIG. 1, items H-N of GUI 115b can cycle around the perimeter of the display screen of assistant device 110 at a default speed until all seven items of content are displayed. Assistant device 110 can determine an average rate of speech (e.g., measuring a speech tempo representing a number of syllables spoken by a user within a threshold time period). However, if the user's speech is faster than the average rate that the user typically speaks, or within a threshold rate range representing urgency, then the animation can be performed faster, or the animation can be skipped altogether (e.g., the transition from GUI 115a to GUI 115b can be performed without any sort of transitional animations or graphics). This can be useful because a user might be in a hurry and want to parse through information quickly if they urgently want information. In some implementations, if the user is speaking slower than the average rate, then the transitional animations or graphics can be slowed down or more animations or graphics can be provided.

In some implementations, assistant device 110 can analyze the characteristics of the speech and generate a score or metric that can be used to determine whether the speech is correlated with a characteristic, such as lacking confidence. For example, a score within a threshold range of scores can be associated with speech lacking confidence. Similar analysis can also be used regarding the visual characteristics, as discussed later herein.

FIG. 3 illustrates an example of a block diagram providing a GUI based on characteristics of voice input and/or a user. In FIG. 3, at block 305, a GUI can be provided by an assistant device. For example, GUI 115b in FIG. 1 can be provided on a display screen of assistant device 110. At block 310, voice input including a keyword can be received. For example, in FIG. 1, speech 120c can be received in response to GUI 115b being provided on the display screen of assistant device 110. At block 315, characteristics of the voice input can be determined. For example, how the keyword was spoken can be determined. At block 315, the GUI can be adjusted based on the voice input and characteristics. For example, the action corresponding to the keyword can be performed and the GUI can be displayed based on the determined characteristics.

In some implementations, visual characteristics of user 105 can also be determined and used to generate a GUI. For example, whether user 105 is looking at display screen 105 can be determined and used to generate GUIs 115a-c. That is, the orientation of user 105's eyes can be determined and used to generate the GUIs. In some implementations, the distance of user 105 can be determined and used to generate GUIs 115a-c. For example, if user 105 is closer to assistant device 110, then the items of the GUI can be smaller (as depicted in GUIs 115a and 115b), but if user 105 is farther away, the items can appear larger in size (as depicted with items O and P of GUI 115c). This can be determined by using a camera of or accessible by assistant device 110 that can be used to generate image frames of the environment around assistant device 110 which can be analyzed using image recognition techniques for such determinations.

In another example regarding visual characteristics of user 105, the motion or movements of user 105 can be determined and used to generate the GUI. For example, if user 105 is moving rapidly within the environment, then this can indicate a sense of urgency and, therefore, similar operations can be performed as when a user speaks quickly, as discussed above.

In some implementations, assistant device 110 can be trained to recognize the keywords. For example, some users might prefer to say “next” as depicted in FIG. 1 to instruct assistant device 110 to provide a new list of results of a search provided via a GUI. However, some users might prefer to say “more” rather than “next.” Thus, users and assistant device 110 can be “trained” to determine which phrase to associate with functionality to interact with the GUI. For example, assistant device 110 can determine that cycling through a list of results is a common task for a user to perform and, therefore, can request the user to say out loud how the user wants to perform that task via speech. The user can say “next,” “more,” or other keywords or phrases that can be picked up by assistant device 110 via its microphone and the phrase provided can be used to implement the functionality to cycle through a list of results. Thus, different users might use different keywords or phrases to request the same functionality or interaction with the GUI.

In another implementation, assistant device 110 can perform different actions when the same command is spoken by different users. For example one user can state “next” which can cause assistant device 110 to transition to the next screen (e.g., providing a new list of the results by generating a new GUI), while when another users says “next” it can cause assistant device 110 to select the next item or piece of content on the existing GUI displayed on the screen.

Many of the aforementioned examples discuss a home environment. In other examples, the devices and techniques discussed herein can also be set up in an office, public facility, etc.

The devices discussed herein, including home assistant device 110, can include one or more processors and memory storing instruction instructions that when executed by the one or more processors can perform the techniques discussed herein.

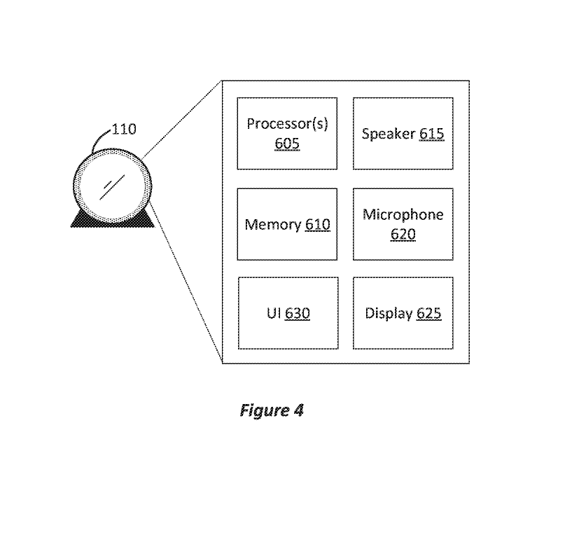

In FIG. 4, assistant device 105 includes a processor 605, memory 610, touchscreen display 625, speaker 615, microphone 635, as well as other types of hardware such as non-volatile memory, an interface device, camera, radios, etc. to implement user interface (UI) logic 630 providing the techniques disclosed herein. Various common components (e.g., cache memory) are omitted for illustrative simplicity. The assistant device is intended to illustrate a hardware device on which any of the components described in the example of FIGS. 1-4 (and any other components described in this specification) can be implemented. The components of the assistant device can be coupled together via a bus or through some other known or convenient device.

The processor 605 may be, for example, a microprocessor circuit such as an Intel Pentium microprocessor or Motorola power PC microprocessor. One of skill in the relevant art will recognize that the terms “machine-readable (storage) medium” or “computer-readable (storage) medium” include any type of device that is accessible by the processor. Processor 605 can also be circuitry such as an application specific integrated circuits (ASICs), complex programmable logic devices (CPLDs), field programmable gate arrays (FPGAs), structured ASICs, etc.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk; a magnetic-optical disk; an optical disk; a read-only memory (ROM) such as a CD-ROM, EPROM, or EEPROM; a magnetic or optical card; or another form of storage for large amounts of data. Some of this data is often written, by a direct memory access process, into memory during the execution of software in the computer. The non-volatile storage can be local, remote or distributed. The non-volatile memory is optional because systems can be created with all applicable data available in memory. A typical computer system will usually include at least a processor, memory, and a device (e.g., a bus) coupling the memory to the processor.

The software can be stored in the non-volatile memory and/or the drive unit. Indeed, storing an entire large program in memory may not even be possible. Nevertheless, it should be understood that for software to run, it may be necessary to move the software to a computer-readable location appropriate for processing, and, for illustrative purposes, that location is referred to as memory in this application. Even when software is moved to memory for execution, the processor will typically make use of hardware registers to store values associated with the software and make use of a local cache that, ideally, serves to accelerate execution. As used herein, a software program is can be stored at any known or convenient location (from non-volatile storage to hardware registers).

The bus also couples the processor to the network interface device. The interface can include one or more of a modem or network interface. Those skilled in the art will appreciate that a modem or network interface can be considered to be part of the computer system. The interface can include an analog modem, an ISDN modem, a cable modem, a token ring interface, a satellite transmission interface (e.g., “direct PC”), or other interface for coupling a computer system to other computer systems. The interface can include one or more input and/or output devices. The input and/or output devices can include, by way of example but not limitation, a keyboard, a mouse or other pointing device, disk drives, printers, a scanner, and other input and/or output devices, including a display device. The display device can include, by way of example but not limitation, a cathode ray tube (CRT), a liquid crystal display (LCD), or some other applicable known or convenient display device.

In operation, the assistant device can be controlled by operating system software that includes a file management system, such as a disk operating system. The file management system is typically stored in the non-volatile memory and/or drive unit and causes the processor to execute the various acts required by the operating system to input and output data, and to store data in the memory, including storing files on the non-volatile memory and/or drive unit.

Some items of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electronic or magnetic signals capable of being stored, transferred, combined, compared, and/or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, those skilled in the art will appreciate that throughout the description, discussions utilizing terms such as “processing” or “computing” or “calculating” or “determining” or “displaying” or “generating” or the like refer to the action and processes of a computer system or similar electronic computing device that manipulates and transforms data represented as physical (electronic) quantities within the computer system's registers and memories into other data similarly represented as physical quantities within the computer system's memories or registers or other such information storage, transmission, or display devices.

The algorithms and displays presented herein are not inherently related to any particular computer or other apparatus. Various general-purpose systems may be used with programs in accordance with the teachings herein, or it may prove convenient to construct more specialized apparatuses to perform the methods of some embodiments. The required structure for a variety of these systems will be apparent from the description below. In addition, the techniques are not described with reference to any particular programming language, and various embodiments may thus be implemented using a variety of programming languages.

In further embodiments, the assistant device operates as a standalone device or may be connected (e.g., networked) to other machines. In a networked deployment, the assistant device may operate in the capacity of a server or of a client machine in a client-server network environment or may operate as a peer machine in a peer-to-peer (or distributed) network environment.

In some embodiments, the assistant devices include a machine-readable medium. While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database and/or associated caches and servers) that store the one or more sets of instructions. The term “machine-readable medium” and “machine-readable storage medium” should also be taken to include any medium that is capable of storing, encoding, or carrying a set of instructions for execution by the machine, and which causes the machine to perform any one or more of the methodologies or modules of the presently disclosed technique and innovation.

In general, the routines executed to implement the embodiments of the disclosure may be implemented as part of an operating system or a specific application, component, program, object, module, or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally, regardless of the particular type of machine- or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disc Read-Only Memory (CD-ROMS), Digital Versatile Discs, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium may typically be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe certain principles and practical applications, thereby enabling others skilled in the relevant art to understand the subject matter, the various embodiments and the various modifications that are suited to the particular uses contemplated.

While embodiments have been described in the context of fully functioning computers and computer systems, those skilled in the art will appreciate that the various embodiments are capable of being distributed as a program product in a variety of forms and that the disclosure applies equally regardless of the particular type of machine- or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details while still being encompassed by the specification. As noted above, particular terminology used when describing certain features or aspects of various embodiments should not be taken to imply that the terminology is being redefined herein to be restricted to any specific characteristics, features, or aspects of the disclosed technique with which that terminology is associated. In general, the terms used in the following claims should not be construed to limit the disclosure to the specific embodiments disclosed in the specification, unless those terms are explicitly defined herein. Accordingly, the actual scope of the technique encompasses not only the disclosed embodiments but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the technique be limited not by this Detailed Description, but rather by any claims that issue on an application based hereon. Accordingly, the disclosure of various embodiments is intended to be illustrative, but not limiting, of the scope of the embodiments, which is set forth in the following claims.

From the foregoing, it will be appreciated that specific embodiments of the invention have been described herein for purposes of illustration, but that various modifications may be made without deviating from the scope of the invention. Accordingly, the invention is not limited except as by the appended claims.

1. A home assistant device comprising:
a display screen;
a microphone;
one or more processors; and
memory storing instructions, wherein the processor is configured to execute the instructions such that the processor and memory are configured to:
provide a first graphical user interface (GUI) on the display screen of the home assistant device;
receive voice input including speech having a keyword representing an action for the assistant device to perform based on the first GUI, the action representing a request for the home assistant device to perform functionality resulting in changes to the GUI;
determine characteristics of the speech and of a user providing the speech, the characteristics of the speech including a speed of the speech spoken by the user; and
generate a second GUI on the display screen based on the action, the characteristics of the speech, and the characteristics of the user, wherein generating the second GUI includes an animation providing changes from the first GUI to the second GUI, a speed of the animation based on the speed of the speech spoken by the user.

2. A method for providing a contextual user interface comprising:
providing, by a processor, a graphical user interface (GUI) on a display screen of an assistant device;
receiving voice input including speech having a keyword representing an action for the assistant device to perform based on the GUI;
determining a confidence level of a user providing the speech; and
adjusting the GUI on the display screen based on the action and the confidence level of the user providing the speech.

3. The method of claim 2, further comprising:
determining characteristics of the speech, wherein adjusting the GUI is further based on the characteristics of the speech.

4. The method of claim 3, wherein the determining characteristics of the speech includes how the speech was spoken.

5. The method of claim 4, wherein the characteristics include one or more of volume, intonation, or cadence of the speech.

6. The method of 2, further comprising:
determining characteristics of the user providing the speech, wherein adjusting the GUI is further based on the characteristics of the user.

7. The method of claim 6, wherein the characteristics of the user includes a physical positioning of the user in relation to the assistant device.

8. The method of claim 2, wherein adjusting the GUI includes providing items having different characteristics than items of the GUI before the adjusting.

9. An electronic device comprising:
one or more processors; and
memory storing instructions, wherein the processor is configured to execute the instructions such that the processor and memory are configured to:
provide a graphical user interface (GUI) on a display screen of an assistant device;
receive voice input including speech provided by a user and having a keyword representing an action for the assistant device to perform based on the GUI;
determine a distance from the user to the electronic device; and
adjust the GUI on the display screen based on the action and the distance from the user to the electronic device.

10. The electronic device of claim 9, wherein the processor is configured to execute the instructions such that the processor and memory are configured to:
determine characteristics of the speech, wherein adjusting the GUI is further based on the characteristics of the speech.

11. The electronic device of claim 10, wherein the determining characteristics of the speech includes how the speech was spoken.

12. The electronic device of claim 11, wherein the characteristics include one or more of volume, intonation, or cadence of the speech.

13. The electronic device of 9, wherein the processor is configured to execute the instructions such that the processor and memory are configured to:
determine characteristics of the user providing the speech, wherein adjusting the GUI is further based on the characteristics of the user.

14. The electronic device of claim 13, wherein the characteristics of the user includes a physical positioning of the user in relation to the assistant device.

15. The electronic device of claim 9, wherein adjusting the GUI includes providing items having different characteristics than items of the GUI before the adjusting.

16. A computer program product comprising one or more non-transitory computer-readable media having computer program instructions stored therein, the computer program instructions being configured such that, when executed by one or more computing devices, the computer program instructions cause the one or more computing devices to:
provide a graphical user interface (GUI) on a display screen of an assistant device;
receive voice input including speech having a keyword representing an action for the assistant device to perform based on the GUI;
determine characteristics of the speech; and
adjust the GUI on the display screen based on the action, wherein the adjusting of the GUI includes adjusting sizes of items of the GUI based on the characteristics of the speech.

17. The computer program product of claim 16, wherein the processor is configured to execute the instructions such that the processor and memory are configured to:
determine characteristics of the speech, wherein adjusting the GUI is further based on the characteristics of the speech.

18. The computer program product of claim 17, wherein the determining characteristics of the speech includes how the speech was spoken.

19. The computer program product of claim 18, wherein the characteristics include one or more of volume, intonation, or cadence of the speech.

20. The computer program product of 16, wherein the processor is configured to execute the instructions such that the processor and memory are configured to:
determine characteristics of a user providing the speech, wherein adjusting the GUI is further based on the characteristics of the user.

21. The computer program product of claim 20, wherein the characteristics of the user includes a physical positioning of the user in relation to the assistant device.
